(19) United States
(12) Patent Application Publication
(10) Pub. No.: US 2009/0125380 A1
(43) Pub. Date: May 14, 2009

(54) System and method for location based suggestive selling

(75) Inventors: Jonathan Otto, Palm Beach, FL (US); Andrew Van Luchene, Santa Fe, NM (US); Raymod J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm beach, FL (US)

(21) Appl. No.: 12/217,861

(22) Filed: Jul. 9, 2008

Related U.S. Application Data
(63) Continuation-in-part of application No. 12/151,038, filed on May 2, 2008.
Application No. 12/151,038 is a continuation-in-part of application No. 12/151,043, filed on May 2, 2008.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00; G06F 15/16; G01C 21/00

(52) U.S. Cl. 705/10; 705/27; 709/206; 705/14; 701/300

(57) ABSTRACT

A system for providing a location based offer, including: an offer element, in a processor for at least one specially programmed general-purpose computer; and a memory unit for the computer. The offer element: generates, using the processor and a first set of rules or a first artificial intelligence program stored in the memory unit, at least one respective offer for an item or service from at least one business entity, the offer for display on a map showing respective locations for the at least one business entity; transmits, according a second set of rules or a second artificial intelligence program stored in the memory unit, the at least one respective offer to a wireless communications device (WCD) for display on a map by the WCD, the map including the respective locations; and receives, from the WCD a selection of an offer from among the at least one respective offer.

### CROSS-REFERENCE TO RELATED APPLICATIONS

This is a continuation-in-part patent application under 35 USC 120 of U.S. patent application Ser. No. 12/151,038, filed May 2, 2008 and entitled “Method and Apparatus for Generating and Transmitting an Order Initiation Offer to a Wireless Communications Device” and of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for providing a location based offer using one or both of a rule or an artificial intelligence program.

### BACKGROUND OF THE INVENTION

It is known to present marketing messages to potential customers. Unfortunately, the messages do not account for the physical location of the target recipient, which information could provide retailers and/or any business or third person with a further opportunity to determine which offers and/or messages are best suited given such current or expected locations.

Thus, there is a long-felt need to provide a system and a method to intelligently and automatically provide marketing messages that are location sensitive and optimize parameters associated with a business entity sending the message while increasing the likelihood of a desired response to the follow-up.

### SUMMARY OF THE INVENTION

The invention broadly comprises a system for providing a location based offer, including: an interface element for at least one specially programmed general-purpose computer; a memory unit for the at least one specially programmed general-purpose computer; and an offer element, in a processor for the at least one specially programmed general-purpose computer. The offer element is for: generating, using the processor and at least one of a first set of rules or a first artificial intelligence program stored in the memory unit, at least one respective offer for at least one item or service from at least one first business entity, the offer for display on a map showing respective locations for the at least one first business entity; transmitting, using the interface element and according to at least one of a second set of rules or a second artificial intelligence program stored in the memory unit, the at least one respective offer to a wireless communications network for transmission to a wireless communications device (WCD) for display on a map by the WCD, the map including the respective locations; and receiving, from the WCD via the wireless communications network and using the interface element, a selection of an offer from among the at least one respective offer.

In one embodiment, the offer element is for: storing, in the memory unit, information regarding historical acceptance of previously presented offers; and modifying the first or second set of rules according to the information regarding historical acceptance of previously presented offers. In another embodiment, the previously presented offers are for items or services from the at least one first business entity or the previously presented offers were sent to the WCD or to an end user associated with the WCD. In a further embodiment, the offer element is for: storing, in the memory unit, data regarding information searches previously performed using the WCD or by an end user of the WCD; and modifying the first or second set of rules according to the data regarding information searches.

In one embodiment, the offer element is for: receiving, from the WCD via the wireless communications network and using the interface element, a request for an item or service; and generating the at least one respective offer to include the item or service. In another embodiment, the WCD includes a memory element for storing at least one third rule, and a processor for executing the at least one respective offer according to the at least one third rule. In a further embodiment, the offer element is for: receiving, using the interface element, at least one third rule from the WCD, or from a general-purpose computer associated with a second business entity; storing the at least one third rule in the memory unit; modifying the at least one offer using the processor and the at least one third rule; and transmitting the modified at least one offer.

In one embodiment, the offer element is for: identifying, using the processor and the interface element, the WCD; determining eligibility of the WCD using the processor and at least one of a third set of rules or a third artificial intelligence program stored in the memory unit; and generating the at least one respective offer only if the WCD is determined to be eligible; or transmitting the at least one respective offer only if the WCD is determined to be eligible. In another embodiment, the offer element is for determining a location for the WCD.

The invention also broadly comprises a method for providing a location based offer.

It is a general object of the present invention to provide a system and a method for providing a location based offer.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention apparatus for generating and transmitting an order initiation offer to a wireless communications device (WCD);

FIG. 2 is a flow chart of a present invention method for generating and transmitting an order initiation offer to a wireless communications device (WCD);

FIG. 3 is a schematic block diagram of a present invention system for providing a location based offer; and,

FIG. 4 is a flow chart of a present invention method for providing a location based offer.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

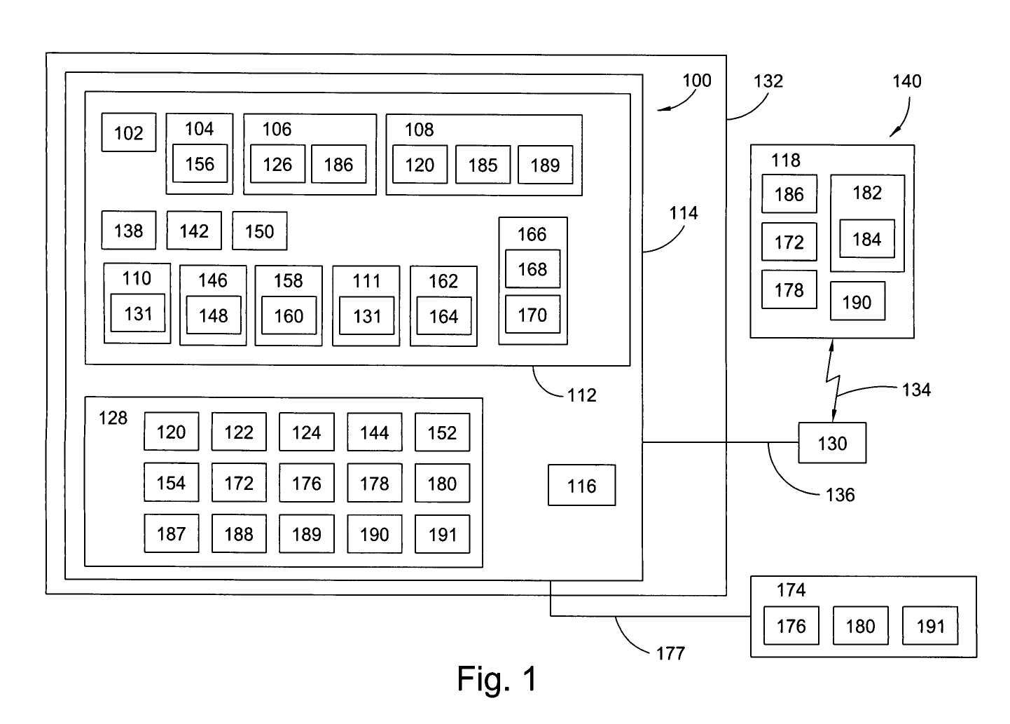

FIG. 1 is a block diagram for present invention system 100 for generating and transmitting an order initiation offer to a wireless communications device (WCD). System 100 includes: identification element 102, eligibility element 104, executable element 106, offer element 108, transceiver element 110, and order initiation element 111, all located in processor 112 of at least one specially programmed general-purpose computer 114. Alternately stated, elements 102, 104, 106, 108, 110, and 111, and any other elements described as being in the processor are functions of the processor or are functions carried out by the processor.

Element 102 identifies, using interface element 116, WCD 118. The eligibility element determines if the WCD is eligible to receive order initiation offer 120. Offer 120 is an offer that is made that when accepted (further described below) initiates a transaction. The executable element is arranged to generate, using one or both of rules 122 and artificial intelligence program 124, at least one executable 126. The set of rules and the artificial intelligence program are stored in memory unit 128. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 172 from a WCD and stores the rule in memory 128. In another embodiment, the WCD is WCD 118. The executable element modifies executable 126 using rule 172. The WCD generates rule 172, and the executable element modifies executable 126 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174, separate from computer 114, transmits modifying rule 176 to computer 114. Computer 174 can be in location 132 (not shown) or can be in a different location. Computer 174 can be associated with a business entity associated with location 132 or can be associated with a different business entity. Connection 177 between computers 114 and 342 is any type known in the art. In another embodiment (not shown), multiple computers 174 are included and respective computers among the multiple computers can be associated with the same or different business entities. Computer 114 stores modifying rule 176 in memory 128. Element 106 modifies executable 126 using rule 176. Computer 174 generates rule 176, and element 106 modifies executable 126, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

The executable is directed toward determining an offer that is most acceptable to an end user of the WCD and best meets prescribed criteria of the entity making the offer. For example, acceptability could be based on price, free items, or other criteria mentioned below. Rules 122 or program 124 are used to find the appropriate combination of acceptability and entity criteria.

The offer element generates, for an eligible WCD and using the at least one executable, an appropriate order initiation offer 120. In general, the core of offer 120 is shaped by, determined by, or consists of executable 126. The transceiver element transmits, using the interface element, the appropriate order initiation offer 120 to wireless communications network 130 for transmission to the WCD. The transceiver element also is arranged to receive, via the interface element, response 131, including an order, from the WCD. Element 111 initiates fulfillment of the order by any means known in the art.

By interface element, we mean any combination of hardware, firmware, or software in a computer used to enable communication or data transfer between the computer and a device, system, or network external to the computer. The interface element can connect with the device, system, or network external to the computer, for example, network 130, using any means known in the art, including, but not limited to a hardwire connection, an optical connection, an Internet connection, or a radio frequency connection. Processor 112 and interface element 116 can be any processor or interface element, respectively, or combination thereof, known in the art.

Computer 114 can be any computer or plurality of computers known in the art. In one embodiment, the computer is located in a retail location with which system 100 is associated, for example, location 132. In another embodiment (not shown), all or parts of the computer are remote from retail locations with which system 100 is associated. In a further embodiment, computer 114 is associated with a plurality of retail locations with which system 100 is associated. Thus, the computer provides the functionality described for more than one retail location. In one embodiment, offer 120 is for an item, good, or service provided by the entity associate with location 132.

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 130, via radio-frequency connection 134. Network 130 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 130 using any means known in the art, including, but not limited to a hardwire connection, an optical connection, an Internet connection, or a radio frequency connection. In the figures, a non-limiting example of a hardwire connection 136 is shown. In one embodiment, device 118 is connectable to a docking station (not shown) to further enable communication between device 118 and system 100. Any docking station or docking means known in the art can be used. That is, when the device is connected to the docking station, a link is established between the device and system 100.

In a first embodiment, system 100 includes location element 138 in the processor, which determines, using the interface element, location 140 for the WCD. The location of the WCD can be determined using any means known in the art, including, but not limited to, GPS technology and information from network 130. Then, the eligibility element determines eligibility in response to location 140, the executable element generates the at least one executable responsive to location 140, or the offer element generates an appropriate order initiation offer responsive to location 140. It should be understood that any combination of the eligibility, executable, and offer elements can operate responsive to location 140. Any criteria known in the art can be used to control the operation of the eligibility, executable, and offer elements responsive to location 140. For example, the elements can operate when the WCD is within a certain specified distance from one or more retail locations, for example, location 132; the elements can operate to generate offer 120 for a specific retail location according to location 140; or the elements can operate to generate offer 120 offering options with respect to a plurality of retail locations (not shown) based on respective distances of the WCD from the plurality of locations.

In a second embodiment, system 100 includes transaction element 142 that accesses transaction history 144, stored in the memory unit, for the WCD or an end user (not shown) associated with the WCD. In one embodiment, the history is stored in a separate computer system (not shown) accessed by system 100. The eligibility element determines eligibility in response to history 144, the executable element generates the at least one executable responsive to history 144, or the offer element generates an appropriate order initiation offer responsive to history 144. It should be understood that any combination of the eligibility, executable, and offer elements can operate responsive to history 144.

Any criteria known in the art can be used to control the operation of the eligibility, executable, and offer elements responsive to history 144. For example, executable 126 can be generated in response to trends noted in the history. The executable can be directed to a continuation of the trend or can derive variants from the trend that may be acceptable to the end user and in the interest of the retail location. Further, the continuation or variants can be aligned with parameters defined for the retail location. For example, the executable can be addressed to a desired promotion, conditions at the retail location, such as stock on hand, or attempts to increase a total bill for the end user.

In another embodiment, history 144 includes searches made using the WCD or communications by the WCD. Alternately stated, system 100 is linked to search browsers associated with the WCD. Any type of search or WCD communication known in the art can be included in history 144. For example, if the WCD has been used to search for products typically available at a retail location similar to location 132, the offer element generates offers for transmission to the WCD when the WCD is within a specified location of such a retail location, for example, location 132. As another example, the communications can be, but are not limited to, telephone calls or email messages to a specific retail location or to a category of retail locations. As another example, if history 144 shows that the WCD has communicated with location 132, then eligibility or the offer can be tailored in response to this information.

In a third embodiment, the eligibility element determines eligibility in response to a time of day, in general, the time of day when the WCD is identified, the executable element generates the at least one executable responsive to the time of day, or the offer element generates an appropriate order initiation offer responsive to the time of day. It should be understood that any combination of the eligibility, executable, and offer elements can operate responsive to the time of day. Any criteria known in the art can be used to control the operation of the eligibility, executable, and offer elements responsive to the time of day. For example, executable 126 can be generated in response to trends for an end user with respect to the time of day or with parameters for the retail location associated with the time of day. The executable can be directed to a continuation of the trend or can derive variants from the trend that may be acceptable to the end user. Further, the continuation or variants can be aligned with parameters defined for the retail location. For example, the executable can be addressed to a desired promotion, conditions at the retail location, such as stock on hand, or attempts to increase a total bill for the end user.

In a fourth embodiment, the eligibility element determines eligibility in response to the day of the week, the executable element generates the at least one executable responsive to the day of the week, or wherein the offer element generates an appropriate order initiation offer responsive to the day of the week. It should be understood that any combination of the eligibility, executable, and offer elements can operate responsive to the day of the week. Any criteria known in the art can be used to control the operation of the eligibility, executable, and offer elements responsive to the day of the week. For example, executable 126 can be generated in response to trends for an end user with respect to the day of the week or with parameters for the retail location associated with the day. In general, this embodiment operates similar to the embodiment directed to the time of day.

In a fifth embodiment, system 100 includes volume element 146, in the processor, which determines transaction volume 148 for at least one retail location, for example, location 132. Element 146 can use any means known in the art to determine volume 148. In one embodiment, element 146 interfaces with another computer system (not shown) associated with location 132 to determine or obtain volume 148. The eligibility element determines eligibility in response to volume 148, the executable element generates the at least one executable responsive to volume 148, or the offer element generates an appropriate order initiation offer responsive to volume 148. It should be understood that any combination of the eligibility, executable, and offer elements can operate responsive to volume 148. Any criteria known in the art can be used to control the operation of the eligibility, executable, and offer elements responsive to volume 148. For example, executable 126 can be generated to create offers that are higher profit (may be less acceptable to an end user) if the volume is high or can generate lower profit (more acceptable offers) if the volume is low. Also, executable 126 can be refined to address respective volume data for various products or groups of products, rather than overall volume.

In a sixth embodiment, system 100 includes order element 150, in the processor, which determine whether an order (not shown) has been placed previously using the WCD. In one embodiment, element 150 interfaces with another computer system (not shown) associated with location 132 to determine or obtain information regarding a previous order. Then, the eligibility element determines eligibility in response to whether an order has been placed previously using the WCD, the executable element generates the at least one executable responsive to whether an order has been placed previously using the WCD, or the offer element generates an appropriate order initiation offer responsive to whether an order has been placed previously using the WCD. It should be understood that any combination of the eligibility, executable, and offer elements can operate responsive to whether an order has been placed previously using the WCD. Any criteria known in the art can be used to control the operation of the eligibility, executable, and offer elements responsive to whether an order has been placed previously using the WCD. For example, executable 126 can be generated to present more acceptable (perhaps lower profit) offers to first time orders from the WCD or can present more acceptable offers to reward continued use of the WCD to place orders.

In a seventh embodiment, element 150 determines whether an order has been placed previously using the WCD during a specified time of day or a specified day of the week. Then, the eligibility element determines eligibility in response to whether an order has been placed previously using the WCD during a specified time of day or a specified day of the week, the executable element generates the at least one executable responsive to whether an order has been placed previously using the WCD during a specified time of day or a specified day of the week, or the offer element generates an appropriate order initiation offer responsive to whether an order has been placed previously using the WCD during a specified time of day or a specified day of the week. It should be understood that any combination of the eligibility, executable, and offer elements can operate responsive to whether an order has been placed previously using the WCD during a specified time of day or a specified day of the week. Any criteria known in the art can be used to control the operation of the eligibility, executable, and offer elements responsive to whether an order has been placed previously using the WCD during a specified time of day or a specified day of the week. This embodiment is a refinement of the previous embodiment. For example, additional temporal criteria are added to the generation of the executable.

In an eighth embodiment, the eligibility element generates, using at least one of set of rules 152 and artificial intelligence program 154, at least one executable 156. Set of rules 152 and artificial intelligence program 154 are stored in the memory unit. The eligibility element is arranged to determine if the WCD is eligible to receive an order initiation using executable 156. In one embodiment, executable 156 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 178 from a WCD and stores the rule in memory 128. In another embodiment, the WCD is WCD 118. Element 104 modifies executable 156 using rule 178. The WCD generates rule 178 and element 104 modifies executable 156 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 180 to computer 114. Computer 114 stores modifying rule 180 in memory 128. Element 104 modifies executable 156, using rule 180. Computer 174 generates rule 180, and element 104 modifies executable 156, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, the eligibility element determines if an end user associated with the WCD is eligible for the order initiation offer. That is, the criteria with respect to eligibility are with respect to an end user of the WCD. In another embodiment, system 100 includes receiving element 158, in the processor, arranged to receive, using the interface element, transmission 160 from the WCD via the communication network. The identification element identifies the WCD in response to the transmission, using any means known in the art. That is, rather than system 100 contacting the WCD to initiate the operations noted above, system 100 initiates the operations after being contacted by the WCD.

In a further embodiment, system 100 includes inventory element 162, in the processor, which obtains inventory information 164. In general, information 164 related to inventory availability, for example, an inventory of product or services in stock or ready for purchase at the retail location. For example, in a restaurant, information 164 might be regarding the number and type of already-prepared breakfast items at the restaurant. In a location selling durable goods, such as appliances, the information could be regarding whether various of the durable goods are in stock at the retail location. In yet another embodiment, element 162 interfaces with another system, for example, a local or centralized computer system associated with operations at the retail location, to obtain information 164, or to obtain data to determine information 164. In a still further embodiment, element 162 compiles the data necessary to determine information 164. For example, operations at the retail location are processed by computer 114. The eligibility element determines eligibility in response to inventory information, for example, if there is a surplus of items on hand, the requirements for eligibility can be loosened, the executable element generates the at least one executable responsive to inventory information, or the offer element generates an appropriate order initiation offer responsive to inventory information, for example, if the supply of items on hand is low, offers for that item can be made more profitable for the retail location.

In one embodiment, system 100 includes registration element 166, in the processor, which communicates with the WCD through the transceiver element. Element 166 transmits information 168 regarding registration of a WCD with system 100, for example, soliciting registration, providing instructions for registering, and promoting registration. Element 166 also receives registration information 170 for the WCD.

In one embodiment, memory element 182 in WCD 118 stores at least one rule 184. Processor 186 in the WCD implements offer 120 according to rule 184. The WCD generates rule 184, and operates on offer 120 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment the offer element determines redemption rate 185 for offer 126. The executable element generates at least one executable 186, using the redemption rate, and at least one of set of rules 187 or artificial intelligence program 188 stored in memory unit 128. The offer element generates appropriate order initiation offer 189 using executable 186, and the transmission element transmits, using the interface element, offer 189 to the wireless communications network for transmission to the WCD.

In another embodiment, the offer element modifies, using the redemption rate, rules 122 or artificial intelligence program 124 to create rules 187 or artificial intelligence program 188, respectively.

In a further embodiment, offers 120 and 189 are transmitted to the WCD regardless of the location of the WCD with respect to a business location, for example, location 132, and stored in memory 182. The location element determines, using the interface element, when the WCD is within a specified distance (not shown) of the business location and retrieves, using the interface element, offer 120 or 189 from memory 182 for presentation, for example, on a point of sale station for the business location. In another embodiment, offers 120 and 189 are stored in memory 128 until the location element, using the interface element, identifies the WCD as being within a specified distance (not shown) of the business location, at which time offers 120 and 189 are transmitted to the WCD.

In one embodiment, computer 114 receives at least one modifying rule 190 from a WCD and stores the rule in memory 128. In another embodiment, the WCD is WCD 118. Element 106 modifies executable 186 using rule 190. The WCD generates rule 190 and element 106 modifies executable 186 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 191 to computer 114. Computer 114 stores modifying rule 191 in memory 128. Element 106 modifies executable 186, using rule 191. Computer 174 generates rule 191, and element 106 modifies executable 186, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

It should be understood that various storage and removal operations, not explicitly described above, involving memory 128 and as known in the art, are possible with respect to the operation of system 100. For example, outputs from and inputs to the general-purpose computer can be stored and retrieved from the memory elements and data generated by the processor can be stored in and retrieved from the memory.

It should be understood that the locating element can determine the distance of the WCD from more than one business, or retail, location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 132 or with a business entity operating the business location. It also should be understood that system 100 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 122 and 152 can be a single set of rules (not shown) or artificial intelligence programs 124 and 154 can be a single program (not shown).

It should be understood that the examples above regarding executables are non-limiting, are meant to provide only a broad overview, and do not address the number, complexity, structure, or interrelationships of the operations included in the actual generation of the executables.

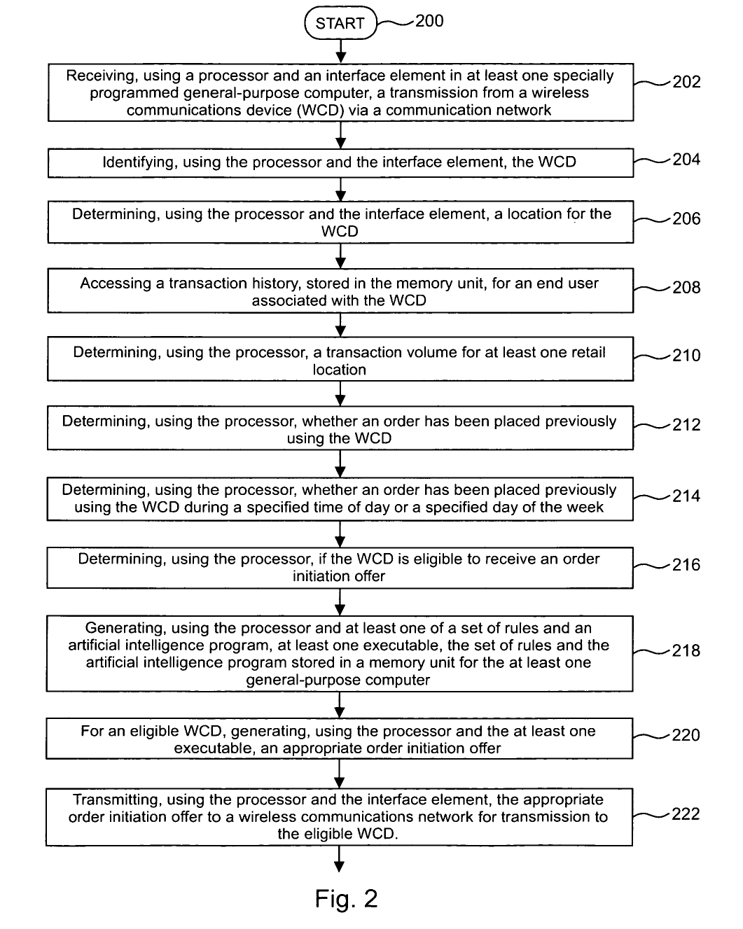

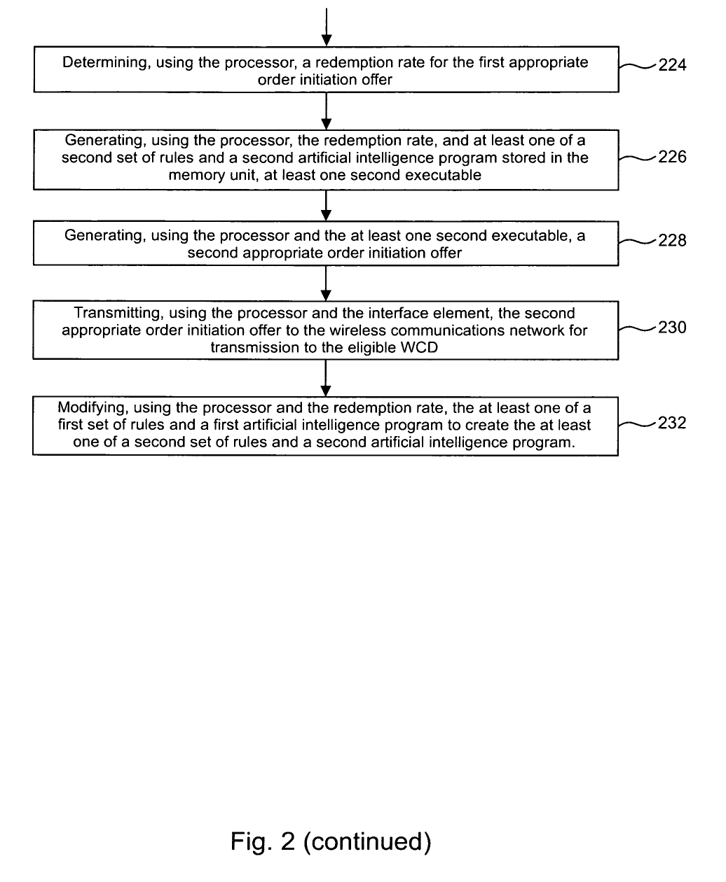

FIG. 2 is a flow chart illustrating a present invention computer-based method for generating and transmitting an order initiation offer to a wireless communications device (WCD). Although the method in FIG. 2 is depicted as a sequence of numbered steps for clarity, no order should be inferred from the numbering unless explicitly stated. The method starts at Step 200. Step 204 identifies, using a processor and an interface element in at least one specially programmed general-purpose computer, a WCD. Step 216 determines, using the processor, if the WCD is eligible to receive an order initiation offer. Step 218 generates, using the processor and at least one of a set of rules or an artificial intelligence program, at least one executable, the set of rules and the artificial intelligence program stored in a memory unit for the at least one general-purpose computer. Step 220, for an eligible WCD, generates, using the processor and the at least one executable, an appropriate order initiation offer. Step 222 transmits, using the processor and the interface element, the appropriate order initiation offer to a wireless communications network for transmission to the eligible WCD.

In a first embodiment, step 206 determines, using the processor and the interface element, a location for the WCD and determining if the WCD is eligible to receive an order initiation offer includes determining in response to the location, generating at least one executable includes generating the at least one executable responsive to the location, or generating an appropriate order initiation offer includes generating the appropriate order initiation offer responsive to the location.

In a second embodiment, step 208 accesses a transaction history, stored in the memory unit, for an end user associated with the WCD and determining if the WCD is eligible to receive an order initiation offer includes determining in response to the transaction history, and generating at least one executable includes generating the at least one executable responsive to the transaction history, or generating an appropriate order initiation offer includes generating the appropriate order initiation offer responsive to the transaction history. In one embodiment, the history includes searches made using the WCD or communications by the WCD. Alternately stated, the method links to search browsers associated with the WCD. Any type of search or WCD communication known in the art can be included in the history. For example, if the WCD has been used to search for products typically available at a retail location similar to the retail location, step 220 generates offers for transmission to the WCD when the WCD is within a specified location of such a retail location. As another example, the communications can be, but are not limited to, telephone calls or email messages to a specific retail location or to a category of retail locations. As another example, if the history shows that the WCD has communicated with the retail location, then steps 216 or 220 can be tailored in response to this information.

In a third embodiment, step 210 determines, using the processor, a transaction volume for at least one retail location and determining if the WCD is eligible to receive an order initiation offer includes determining in response to the transaction volume, and generating at least one executable includes generating the at least one executable responsive to the transaction volume, or generating an appropriate order initiation offer includes generating the appropriate order initiation offer responsive to the transaction volume.

In a fourth embodiment, step 212 determines, using the processor, whether an order has been placed previously using the WCD and determining if the WCD is eligible to receive an order initiation offer includes determining in response to whether an order has been placed previously using the WCD, and generating at least one executable includes generating the at least one executable responsive to whether an order has been placed previously using the WCD, or generating an appropriate order initiation offer includes generating the appropriate order initiation offer responsive to whether an order has been placed previously using the WCD.

In a fifth embodiment, step 214 determines, using the processor, whether an order has been placed previously using the WCD during a specified time of day or a specified day of the week and determining if the WCD is eligible to receive an order initiation offer includes determining in response to whether an order has been placed previously using the WCD during the specified time of day or the specified day of the week, and generating at least one executable includes generating the at least one executable responsive to whether an order has been placed previously using the WCD during the specified time of day or the specified day of the week, or generating an appropriate order initiation offer includes generating the appropriate order initiation offer responsive to whether an order has been placed previously using the WCD during the specified time of day or the specified day of the week.

In a sixth embodiment, step 216 obtains, using the processor, inventory information and determining if the WCD is eligible to receive an order initiation offer includes determining in response to the inventory information, and generating at least one executable includes generating the at least one executable responsive to the inventory information, or generating an appropriate order initiation offer includes generating the appropriate order initiation offer responsive to the inventory information.

In a seventh embodiment, step 224 determines, using the processor, a redemption rate for the first appropriate order initiation offer; step 226 generates, using the processor, the redemption rate, and at least one of a second set of rules and a second artificial intelligence program stored in the memory unit, at least one second executable; step 228 generates, using the processor and the at least one second executable, a second appropriate order initiation offer; and step 230 transmits, using the processor and the interface element, the second appropriate order initiation offer to the wireless communications network for transmission to the eligible WCD. In an eighth embodiment, step 232 modifies, using the processor and the redemption rate, the at least one of a first set of rules and a first artificial intelligence program to create the at least one of a second set of rules and a second artificial intelligence program.

In a ninth embodiment, determining, using the processor, if the WCD is eligible to receive an order initiation offer includes using at least one of the set of rules or the artificial intelligence program. In a tenth embodiment, determining if the WCD is eligible to receive an order initiation offer includes determining if an end user associated with the WCD is eligible for the order initiation offer. In an eleventh embodiment, determining if the WCD is eligible to receive an order initiation offer includes determining eligibility in response to the time of day, generating at least one executable includes generating the at least one executable responsive to the time of day, or generating an appropriate order initiation offer includes generating the appropriate order initiation offer responsive to the time of day. In a twelfth embodiment, determining if the WCD is eligible to receive an order initiation offer includes determining in response to a day of the week, generating at least one executable includes generating the at least one executable responsive to the day of the week, or generating an appropriate order initiation offer includes generating the appropriate order initiation offer responsive to the day of the week.

In a thirteenth embodiment, step 202 receives, using the processor and the interface element, a transmission from the WCD via the communication network and identifying a WCD includes identifying the WCD in response to the transmission.

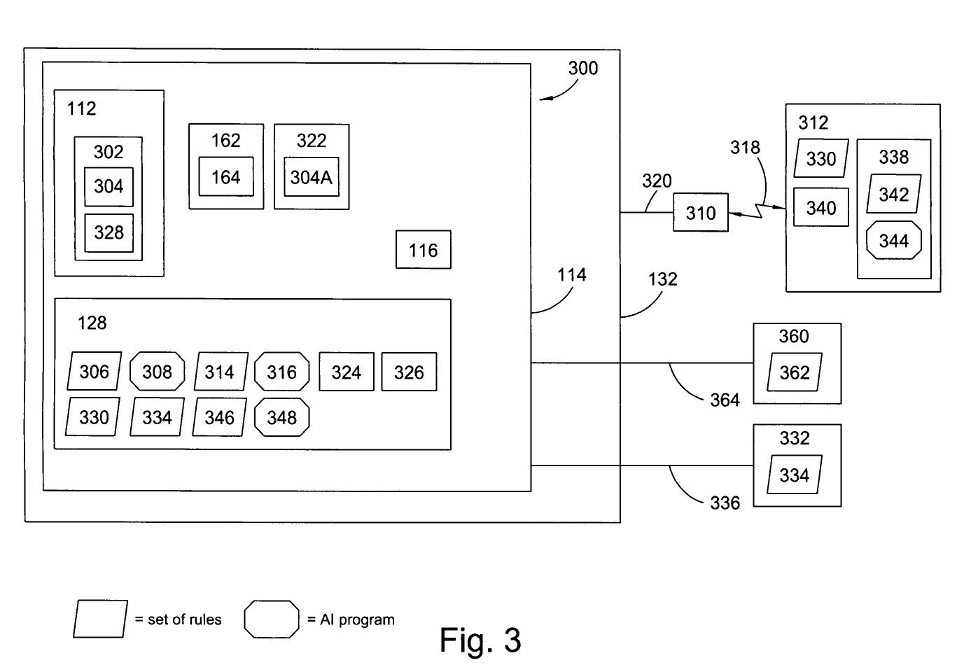

FIG. 3 is a schematic block diagram of present invention system 300 for providing a location based offer. The system includes offer element 302 in processor 112. In one embodiment, the offer element is for generating at least one respective offer 304 using one or both of set of rules 306 or artificial intelligence program 308 stored in memory unit 128. Alternately stated, element 302 and any other elements described as being in the processor are functions of the processor or are functions carried out by the processor. Offer 304 is for at least one item or service (not shown) from at least one business entity. That is, the offer is for an item or service that is offered by, or provided by, the at least one business entity. Alternately stated, the at least one business entity is associated with the offer. The offer is for display on a map (not shown) showing respective locations for the at least one business entity. In the discussion that follows, a business entity associated with location 132, for example a business entity that owns or operates location 132, is used as a non-limiting example; however, it should be understood that more than one business entity and more than one location are included in the spirit and scope of the claimed invention. As well, any combination of multiple business entities and multiple locations are included in the spirit and scope of the claimed invention. For example, a business entity can be associated with multiple locations.

Thus, respective offers can be generated for one or more business entities, each of which is associated with one or more locations, and the map noted above is to show various locations associated with the business entities. It should be understood that the various locations can include all the locations associated with a business entity or only some of the locations associated with a business entity.

In one embodiment, the offer element transmits, using the interface element, offer 304 to wireless communications network 310 for transmission to wireless communications device (WCD) 312 according to one or both of set of rules 314 or artificial intelligence program 316 stored in the memory unit, as further described infra. The WCD displays, on the map noted above, offer 304 and the respective locations for the business entities as further described infra. In one embodiment, the offer element generates offer 304 using rules 306 or program 308 and transmits the offer without the use of rules 314 or program 316. In one embodiment, the offer element generates offer 304 without using rules 306 or program 308 and transmits the offer with the use of rules 314 or program 316. In one embodiment, the offer element generates offer 304 using rules 306 or program 308 and transmits the offer with the use of rules 314 or program 316.

WCD 312 is connected to wireless communications network 310 with radio frequency connection 318. Network 310 is connected to computer 114 with hardwire connection 320. The discussion, in the description of FIG. 1, of WCD 118 and network 130 is applicable to WCD 312 and network 310, respectively. Although only one WCD is shown receiving offer 304 in the figures, it should be understood that the offer can be sent to a plurality of WCDs. In one embodiment, the plurality of WCDs is associated with a same end user or end users. In another embodiment, various WCDs in the plurality of WCDs are associated with different end users.

In general, offer 304 is directed to reaching one or more goals established by the business entity or entities noted supra offering or providing the item or service included in offer 304, or optimizing one or more parameters associated with operations of the preceding business entity or entities. That is, generating an order offer includes making a selection of one or more choices from among two or more choices that yields the best or optimized outcome or yields. Ideal can mean optimizing or maximizing revenues, profits, item counts, average check, market basket contents, marketing offer acceptance, store visitation or other frequency measures, or improving or optimizing speed of service, inventory levels, turns, yield, waste, or enhancing or optimizing customer loyalty or use of kiosks or internet or other POS devices or self service devices, or use of off peak or other coupons or acceptance of Upsell or other marketing offers, or reduction or optimization of any customer or cashier or any other person's gaming, fishing, or any other undesirable action or activities and/or failures to act when desired, or minimizing or optimizing any dilution or diversion of sales, profits, average check, or minimizing or optimizing use of discounts and other promotions so as to maximize or optimize any of the foregoing desired actions, outcomes or other desired benefits, or any combination of minimizing undesired results while maximizing or optimizing any one or more of any desired results.

In like manner, the transmission of offer 304 is directed to reaching one or more goals established by the business entity or entities noted supra offering or providing the item or service included in offer 304, or optimizing one or more parameters associated with operations of the preceding business entity or entities. Any aspect of the transmission, for example, but not limited to, timing of the transmission, or format of the transmission can be executed in light of the considerations noted in the preceding paragraph.

In addition to methods that may be disclosed herein, methods to generate or transmit the offer are disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices;” and commonly-owned U.S. patent application Ser. No. 12/151,038, filed May 2, 2008 and entitled “Method and Apparatus for Generating and Transmitting an Order Initiation Offer to a Wireless Communications Device.”

In one embodiment, the discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the generation and transmission of offer 304, in particular, to the selection of items, services, or incentives to be included in the offer. In another embodiment, the discussion of the generation of an offer as disclosed by commonly-owned U.S. patent application Ser. No. 12/151,038, filed May 2, 2008 and entitled “Method and Apparatus for Generating and Transmitting an Order Initiation Offer to a Wireless Communications Device” is applicable to the generation and transmission of offer 304, in particular, to the selection of items, services, or incentives to be included in the offer.

The offer element is arranged to receive, from the WCD via the wireless communications network and using the interface element, selection 322 of offer 304A from among respective offers 304. For example, if offer 304 includes a plurality of offers, for example, from a plurality of business entities or locations, the offer element receives a selection, made via the WCD, of one or more of the offers. It should be understood that more than one selection can be received and that a selection can include more than one offer.

In one embodiment, the offer element stores information 324 regarding historical acceptance of previously presented offers and modifies rules 306 or 314 according to information 324. In one embodiment, the offer element uses program 308 or 316 to modify rules 306 or 314. In one embodiment, the previously presented offers are for items or services from one or more of the business entities or business locations associated with offer 304. Thus, the information is directed to the performance of offers, which could include offers not presented to the WCD or end users associated with the WCD, with respect to the associated business entities.

In one embodiment, the previously presented offers were sent to the WCD or to an end user associated with the WCD. Thus, the information is directed to the performance of offers, which could include offers not made by the associated business entities, made to the WCD. In one embodiment, the previous offers were made to any end user device associated with a particular end user or group of end users. Alternately stated, information 324 tracks overall customer buying habits or tracks overall customer responses, including, accept rates or use of coupons and other suggestive selling or marketing offers, with respect to the associated entities, or tracks individual customer buying habits or tracks customer responses, including, accept rates or use of coupons and other suggestive selling or marketing offers.

For example, the offer element can increase the frequency, in offer 304, of items, services, or incentives that have higher acceptance rates according to information 324 and can link items, services, and incentives to other parameters, such as time of day, that have affected the acceptance of the items, services, or incentives according to information 324. Such learning/modification can make use of any or all customer or other information as

In one embodiment, the offer element stores data 326 regarding information searches previously performed using the WCD or by an end user of the WCD, and modifies rules 306 or 314 according to data 326. For example, the data could be regarding keyword searches performed using the WCD or by an end user of the WCD. Data 326 can be used to discern patterns or other aspects regarding the use of the WCD or activities of the end users that can be useful in forming or transmitting offer 304.

The discussion in commonly-owned U.S. patent application Ser. No. 11/983,679, filed Nov. 9, 2006 and entitled “Method and System for Generating, Selecting, and Running Executables in a Business System Utilizing a Combination of User Defined Rules and Artificial Intelligence” regarding the modification of rules is applicable to the modification of rules 306 or 314 by the offer element. The discussion supra regarding history 144 is applicable to information 324 and data 326.

As disclosed in commonly-owned U.S. patent application titled: “METHOD AND APPARATUS FOR GENERATING AND TRANSMITTING AN IDEAL ORDER OFFER,” inventors Otto et. al, filed concurrently, which application is incorporated by reference herein, in one embodiment, the offer element reviews information 324 to identify an item or service not included in the history (an presumably never ordered by the customer) or ordered by the customer at less than a predetermined frequency. Then, the offer element includes, in the offer, the item or service not included in the information or ordered at less than a predetermined frequency.

In one embodiment, the offer element is arranged to receive, from the WCD via the wireless communications network and using the interface element, request 328 for an item or service (not shown) and generates offer 304 to include the item or service. For example, a keyword search directed to a product or service could be generated using the WCD and received by system 300. The offer element then uses the product or service referenced in the keyword search as at least a starting point for generating offer 304. For example, offer 304 could include only the product or services referenced in the search or could also include other products or services.

In one embodiment, computer 114 receives at least one modifying rule 330 from WCD 312 or from another EUD (not shown) associated with an end user or end users for WCD 312, and stores the rule in memory 128. Element 302 modifies offer 304 using rule 330. The WCD or EUD generates rule 330 and element 302 modifies offer 304 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 332 transmits at least one modifying rule 334 to computer 114. Computer 114 stores modifying rule 334 in memory 128. Element 302 modifies offer 304 using rule 334. Computer 332 generates rule 334, and element 302 modifies offer 304 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In one embodiment (not shown), multiple computers 332 are included and respective computers among the multiple computers can be associated with the same or different business entities. Computer 332 is connected to computer 114 by any means known in the art, for example, hardwire connection 336.

In one embodiment, WCD 312, includes memory element 338 and processor 340. WCD 312 stores at least one rule 342 in the memory element and processor 340 executes offer 304 according to rule 342. The discussion, in the description of FIG. 1, of WCD 118 and rule 184 is applicable to WCD 312 and rule 342, respectively. For example, the WCD generates rule 342, and operates on offer 304 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In one embodiment, artificial intelligence program 344 is stored in memory 338 and WCD 312 executes offer 304 using program 344. In another embodiment, WCD 312 executes offer 304 using program 344 and rule 342.

In one embodiment, the offer element identifies, using the interface element, the WCD and determines eligibility of the WCD using one or both of set of rules 346 or artificial intelligence program 348 stored in the memory unit. The WCD can be identified by any means known in the art. In one embodiment, the offer element generates offer 304 only if the WCD is determined to be eligible. In one embodiment, the offer element transmits offer 304 only if the WCD is determined to be eligible. In one embodiment, the offer element generates offer 304 only if the WCD is determined to be eligible and the offer element transmits offer 304 only if the WCD is determined to be eligible. The present invention is not limited to any criteria for determining eligibility. For example, eligibility can be determined based on information 324, data 326, other information regarding the WCD or end users, or other information related to associated business entities, such as operational information. In one embodiment, inventory information 164 is used for some or all of the operational information.

In one embodiment, the offer element, using the interface element, determines a location for the WCD using any means known in the art. In another embodiment, the location of the WCD is used as a reference point in the map to be displayed by the WCD.

As disclosed in commonly-owned “METHOD AND APPARATUS FOR GENERATING AND TRANSMITTING AN IDEAL ORDER OFFER,” inventors Otto et. al, filed concurrently, in one embodiment, based upon the acceptance or rejection rates by a customer or customers of offers, such as offer 304, the system determines that a particular offer is either desirable or undesirable. If found to be undesirable, e.g., due to a higher than average rejection rate, and/or based upon any other financial or statistical means, e.g., profit margins, gaming, dilution, fishing, diversion, speed of service, customer frequency, customer satisfaction survey or other results, e.g., via a voice survey, inventory control, corporate objectives, average check, average item counts, market basket analysis, labor rates, and/or any other measure or combination of the foregoing, system 300 can cease to offer such orders to the same or similar customers or to all customers.

It should be understood that various storage and removal operations, not explicitly described above, involving memory 128 and as known in the art, are possible with respect to the operation of system 300. For example, outputs from and inputs to the general-purpose computer can be stored and retrieved from the memory elements and data generated by the processor can be stored in and retrieved from the memory.

It should be understood that system 300 can be operated by the same business entity operating or owning a business location using the system, or can be operated by a third party different than the business entity operating or owning the business location using the system. In one embodiment, a third party operates system 300 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 300 can be integral with a computer operating system for a business location, for example, location 132 or with a business entity operating the business location. It also should be understood that system 300 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 306 and 314 can be a single set of rules (not shown), or programs 310 and 348 can be a single program (not shown).

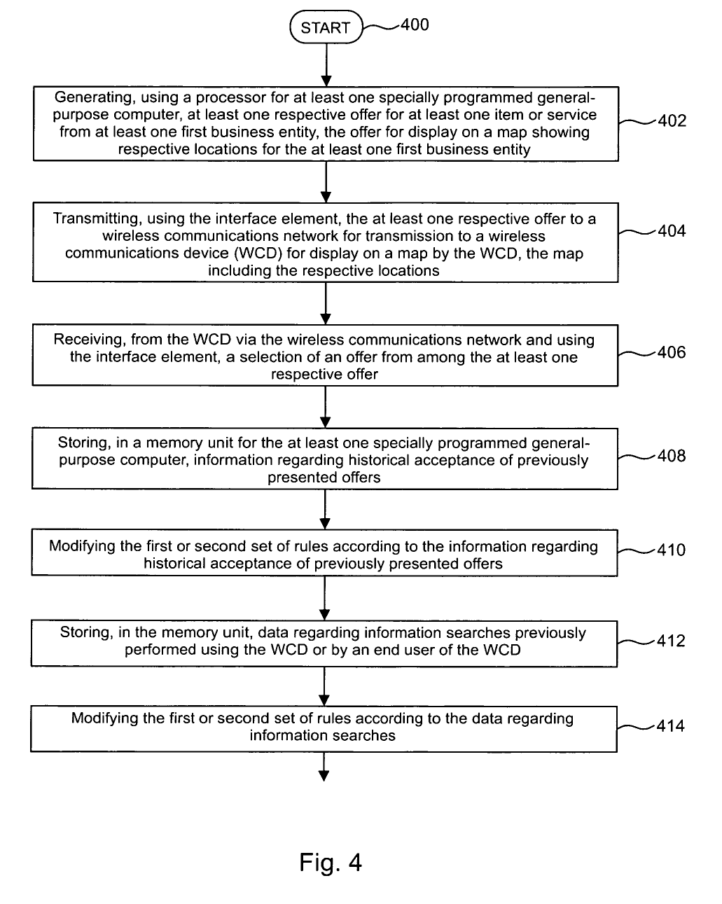

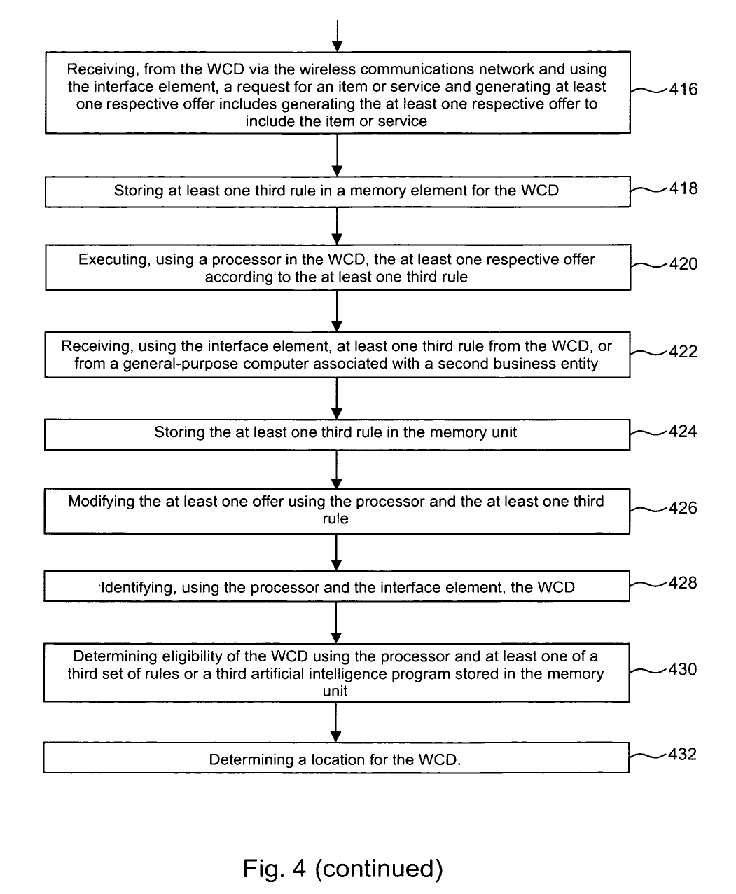

FIG. 4 is a flow chart illustrating a present invention computer-based method for providing a location based offer. Although the method in FIG. 4 is depicted as a sequence of numbered steps for clarity, no order should be inferred from the numbering unless explicitly stated. The method starts at Step 400. Step 402 generates, using a processor in at least one specially programmed general-purpose computer, at least one respective offer for at least one item or service from at least one first business entity, the offer for display on a map showing respective locations for the at least one first business entity. Step 404 transmits, using the interface element, the at least one respective offer to a wireless communications network for transmission to a wireless communications device (WCD) for display on a map by the WCD, the map including the respective locations. Step 406 receives, from the WCD via the wireless communications network and using the interface element, a selection of an offer from among the at least one respective offer. In one embodiment, the at least one respective offer is generated by using at least one of a first set of rules or a first artificial intelligence program stored in a memory unit for the at least one specially programmed general-purpose computer. In one embodiment, the at least one respective offer is transmitted according to at least one of a second set of rules or a second artificial intelligence program stored in the memory unit.

Step 408 stores, in the memory unit, information regarding historical acceptance of previously presented offers, and step 410 modifies the first or second set of rules according to the information regarding historical acceptance of previously presented offers. In one embodiment, the previously presented offers are for items or services from the at least one first business entity, or the previously presented offers were sent to the WCD or to an end user associated with the WCD. Step 412 stores, in the memory unit, data regarding information searches previously performed using the WCD or by an end user of the WCD; and step 414 modifies the first or second set of rules according to the data regarding information searches.

Step 416 receives, from the WCD via the wireless communications network and using the interface element, a request for an item or service and generating at least one respective offer includes generating the at least one respective offer to include the item or service. Step 418 stores at least one third rule in a memory element for the WCD, and step 420 executes, using a processor in the WCD, the at least one respective offer according to the at least one third rule. Step 422 receives, using the interface element, at least one third rule from the WCD, or from a general-purpose computer associated with a second business entity; step 424 stores the at least one third rule in the memory unit; and step 426 modifies the at least one offer using the processor and the at least one third rule. In one embodiment, transmitting the at least one offer includes transmitting the modified at least one offer. Step 428 identifies, using the processor and the interface element, the WCD, and step 430 determines eligibility of the WCD using the processor and at least one of a third set of rules or a third artificial intelligence program stored in the memory unit. In one embodiment, generating the at least one respective offer includes generating the at least one respective offer only if the WCD is determined to be eligible; or transmitting the at least one respective offer includes transmitting the at least one respective offer only if the WCD is determined to be eligible. Step 432 determines a location for the WCD.

The following should be viewed in light of FIGS. 3 and 4 and commonly-owned “METHOD AND APPARATUS FOR GENERATING AND TRANSMITTING AN IDEAL ORDER OFFER,” inventors Otto et. al, filed concurrently. In the discussion that follows, reference may be made to a present invention system; however, it should be understood that such references also are applicable to a present invention method.

A combination of table-based operations, sets of rules, or artificial intelligence programming, as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; and commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices,” can be used to optimize the generation and transmission of offers 304 at least as follows:
1. Appearance or sound of the offer;
2. Format and content of the offer;
3. Optimal directions from the WCD location to the location for the business entity;
4. When to display the offer;
5. How many offers to transmit for display at any given time;
6. Acceptable locations for the WCD to display the offers;
7. Generating or transmitting offers based on search history with the WCD or related EUDs;
8. Generating or transmitting offers based on a search query conducted by the WCD or the current location of the WCD.

In one embodiment, system 300 charges a fee based on a per order or percent of order fee for each order placed using the system in response to offers 304. In another embodiment, a business entity associated with offers 304 specifies: the offers to generate and transmit using system 300, a schedule for transmitting the offers, device profiles for WCDs to which to transmit the offer, and a maximum amount the entity authorizes for offers in a given time period. In a further embodiment, pick up instructions are determined based on the nature of the WCD, for example, distinguishing between a hand-held device and a device mounted in a vehicle. For example, if an order at a fast food restaurant is placed by GPS unit in a vehicle, in response to offer 304, instructions are transmitted to GPS to go to a drive through window at the business location to pick up the order. In one embodiment, an order in response to offer 304 can be placed and fully executed using voice commands.

In one embodiment, upon receipt of offer 304, an end user can accept the offer and initiate or consummate orders associated with using the GPS touch screen or other interface. Initiating an order responsive to offer 304 can be accomplished via any applicable means known in the art, including, for example, by touching a company logo (part of offer 304) on the map of locations noted supra or via a menu input or other selection means.

WCD 312 can be any WCD (described supra) known in the art, for example, a PC, laptop, PDA or cell phone configured with GPS functionality or other features required to enable WCD to function as disclosed invention. For example, a department store customer could order one or more items on line, while at home, then, while driving, the system could determine that the end user is close to a store location that has one or all the ordered items in stock. The system would then display a map, with such as a map showing the store location, enabling the end user to proceed to the store location or to otherwise indicate their intentions of picking up one or all such ordered items. In that event, in one embodiment, the system transmits one or more messages to department store employees to assemble the order and facilitate pick up of the order, for example, placing the order generally near the front door or other loading door or other designated area, or simply place the items in a shopping basket or pallet (for unusually large items/orders). Each or all of these steps/methods may be used, separately or in some combination or sequence. For example, the employee(s) may assemble the items in a shopping cart or basket, leaving the basket in the back room or other designated area away from the main shopping area, and, upon the arrival of the customer, bring the shopping cart to the door, other area, or to the customer's car.

In one embodiment, some or all interaction with the WCD can be accomplished in whole or in part using voice interaction or voice commands, or voice prompts. In some embodiment, the system displays orders, items, offers, messages or provides an audible or spoken version or otherwise communicates audibly via the WCD.

The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic to determine when or when not to make certain offers, or to provide a different or improved incentive to use certain ordering devices or payment methods, based upon, but not limited to, any one or more of:
1. One or more business, customer or sponsor objectives.
2. Location of a device used to enter a transaction or location or device that receives or displays a marketing message or offer or that is otherwise controlled or affected by one or more marketing systems, including, for example, at a point of sale (POS) Terminal, WCD, Internet Enabled Device, Cell Phone, Kiosk, Laptop or PC, or any other device, or a location, e.g., at a retail outlet, quick service restaurant, drive through, front counter, kiosk station, table, at home, on the road, passing by, walking by, driving by, walking or driving near to, entering or leaving a location, or any other device or location information available to any such marketing system(s).
3. Temporal parameters, such as, time of day, day of week, month, or year.
4. Any one or more data or variables available or accessible, including, for example, any customer, business or sponsor information, such as, membership in a loyalty or other marketing program, ordering preferences or history, current sales volumes or budgets or targets, current or planned local, regional or national marketing programs or objectives, device preferences, for example, use of a kiosk in preference to a front counter or other device, current speed of service, quality of service or other operating data, budgets, objectives or trends, etc.

In a further embodiment, the present invention employs any one or more or any combination of the following, including, but not limited to discriminating based upon:
1. Location
2. Transaction Entry Device
3. Customer Information or objectives
4. Business Information or objectives
5. Sponsor Information or objectives
6. Marketing Program Type
7. Opt In Information
8. Offer Type
9. Payment method or terms or conditions of payment
10. Marketing Message Contents
11. Marketing Offer Objectives
12. Expected or Actual System Results or tracking data
13. System determined discounts or other incentives required to achieve desired results
14. One or more table entries provided by one or more end users, for example, a system administrator
15. One or more rules provided by one or more end users, for example, a system administrator
16. One or more genetic algorithms or other AI based rules or determination methods
17. Any other information, data, rules, system settings, or otherwise available to the marketing system or disclosed invention or the POS system or other system designed to deliver one or more marketing messages, offers, or coupons, etc.
18. Any combination or priority ranking of any two or more of the foregoing

In one embodiment, marketing messages, content, offers, incentives, etc., are created or maintained centrally or in a distributed network, including, for example, locally. Such management may be accomplished via any applicable means available, including, for example, making use of existing, e.g., off the shelf or customized tools that provide for such creating, management or distribution.

In another embodiment, in an effort to further control or determine which offers to make or to determine which offers are generally more or less desirable, or to otherwise improve one or more aspects of the present invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In one embodiment, the present invention provides such incentives initially, or on an ongoing basis or only until certain objectives are achieved or certain customers or all customers are generally habituated to making use of such certain devices, locations or payment methods, after which, in certain embodiments, the system may cease, temporarily or permanently making such offers based upon such discriminating factors, or may reduce the difference in incentives, or may only periodically provide such full discounts or reduced discounts so as to reinforce such behavior. In another embodiment, a system administrator or other end user establishes such rules or conditions.

In a further embodiment, the present invention makes such determinations using an automated means. Such automated means includes, for example, a system that periodically or generally continuously tests different marketing messages, content, offers or incentives or other methods, for example, user interfaces, or other benefits or incentives, and based upon such testing, determine which offers or incentives or other benefits yield the desired results or frequency of use of any such locations, devices or payment methods. Such automated system may periodically cease making such offers or providing the same or similar incentives or other benefits once it is determined that the desired customer behavior has been established, habituated or otherwise persists without need for such continued offers, incentives or benefits. If such system subsequently determines that the desired behavior has ceased or fallen below a desired level, such system can then reinstate such offers, incentives or benefits. When reinstating such offers, incentives or benefits, the present invention can return to previously successful levels or can provide less or greater incentives, offers or benefits, on a temporary, periodic or permanent basis. Such reinstatement may be provided for all customers, certain customers, classes of customers, or only those customers that have ceased or have generally reduced their frequency of desired behavior or use of generally more desirable devices, locations or payment methods.

In one embodiment, each location associated with the present invention establishes its own rules or learns from local customer behavior or other available information. In another embodiment, the present invention shares some or all available information or results data among any two or more or all locations or locations that fall within a given area, region, geography, type, or other factors, such as menu pricing, customer demographics, etc., and makes use of such information to improve the present invention's ability to determine which offers to make, the extent or duration of offers or incentives or other benefits. For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type, class or other offer or incentive or benefit is particularly effective. By sharing such information among other locations, for example, similar locations, the present invention can begin to make use of the same or similar incentives, offers or benefits in other generally similar locations or with other similar customers or classifications of customers so as to improve the performance of one or more other such locations or all locations. In this fashion, the present invention can learn which offers or incentives or benefits will more quickly or generally achieve the desired results or improve trends towards such results. Likewise, the present invention can more quickly determine which offers, incentives or benefits do not yield the desired results or determine how long such offers, incentives or benefits are required to achieve the desired results.

In a further embodiment, the present invention tests making or not making certain offers, incentives or providing certain benefits on a periodic basis within a single location or among a plurality of locations so as to determine the extent or requirement to make any such offers or to provide incentives or other benefits. For example, by testing making offers and not making offers, the system can determine if any such offers are required at all to drive business transactions to a kiosk or such a system can further determine the extent of any gaming, dilution, diversion or accretion. By alternating making and not making offers or by testing various levels of incentives or discounts, the disclosed system can better determine the optimal incentive, discount or benefits required, if any, to achieve the desired results, while minimizing or mitigating any undesirable effects of using or deploying such system. Such testing can be accomplished via any applicable or available means, including those previously disclosed by applicants herein and within the referenced applications, or randomly or using rules or AI based systems. By periodically testing or making changes to such offers, incentives or benefits, the system can continually strive to achieve the optimal mix and level of offers, discounts, marketing messages, marketing offers, benefits, loyalty or marketing program benefits or otherwise. By combining the use of one or more of a table, rules or AI based system, including, for example, as disclosed in the applications incorporated by reference herein, a more effective marketing system may be developed and deployed that achieves optimal or nearly optimal results over both the short and long term, without generally becoming static.

In one embodiment, the present invention tests customers of one or more locations using discounts or other marketing offers, while maintaining the regular prices at one or more other locations. By comparing the results data from such test and control groups of locations, the system can better determine which offers, discounts, etc., are accretive or provide net benefit or are subject to gaming, fishing or other fraudulent or undesirable activities. Such testing can be performed within a single unit as well, by periodically making and not making such offers to the same or similar customers or by randomly providing such offers or not making such offers. In another embodiment, the present invention makes use of a combination of such testing methodologies in order to best determine which offers yield optimal or the best results given the system information, parameters or any one or more customer, business, sponsor or system objectives. For example, the present invention tests in a single or group of stores certain new or untested offers, and, combines such test with a periodic offer, for example, toggling, between making and not making offers, which toggling, may be random, 50/50, or may be intelligently determined based upon present invention information, and continue such test for a period of time, for example, one month, while comparing results of such tests with a similar number of stores in a control group, and then, switch the process, for example, test within the original control group and stop making offers within the original test group. In this fashion the present invention determines the effects of turning on or off certain offers or types of offers and the effect of such offers on customers, customer buying habits, store or business results, or any other measures, including, for example, testing for dilution, diversion, accretion, gaming or fishing.

In one embodiment, prospective customers or other end users are notified via any applicable means including, but not limited to:
1. Email message 2. Pop up window, banner ad, hyperlink or other online or website advertisement or communications.
3. Voice mail message
4. Text message
5. Cell phone or other telecommunications, for example, telemarketing
6. Any combination of the foregoing

In one embodiment, the present invention sends notification messages or marketing messages or offers or other incentives or benefits, using any one or more of the preceding communications methods and, in certain embodiments, tests which method(s) are generally more or less effective in generating the desired results or optimal results. Such system may test such communications or notifications using any applicable means, including table, rules or AI based determination means, or by periodic or random testing. By testing each method, the system can determine which methods of communication are more effective generally or by class or category of customer or based upon the type of communication or offer or incentive or other benefit. For example, by using such testing, the system may determine that offers to use a cell phone for order entry or other transaction processing is generally more effective when such message/offer is delivered via cell phone, text message, with a built in discount or other offer.

In one embodiment, an administrator can add or change or otherwise modify the previous listing, or data, or determine the order of priority or preference of each such discrimination factors or preferences or data, including, for example, location, payment or device, ranking each in order of such preference or providing table, rules or other entries to provide or assist or to support determining which are preferred or the amount of incentive available or increased or decreased incentive, as a percentage or absolute or relative or other dollar or other calculation method to determine what offers, if any to make, at which locations, devices or payment methods or other discriminating factors, for example, customer or business preferences or customer, business, sponsor or other entity information, objectives, rules or other available information or rules or system settings. By providing or otherwise manually or automatically determining such rankings, the disclosed invention can initially or continuously evaluate potential marketing offers or messages and modify or deliver such marketing messages or offers or provide other incentives to drive a desired percentage of business or customer transactions to one or more particular devices, locations or payment methods.

In a further embodiment, a system administrator is permitted to enter or modify or delete or otherwise provide such marketing messages or notification content using an interface provided for such purposes. When establishing such messages or content, such administrator or other end user may be further permitted to designate which messages or content are to be generally used when using a particular type of communications. For example, one type of message or content may be designated for use when communicating via cell phone and another message or content for email and still other versions for each or all of the other various methods of communications. In one embodiment, the present invention tests each provided message or content with each such communications method to determine, partially or wholly, which message or content yields the best or optimal results over time or based upon any available information, including, for example, any available or otherwise accessible customer, business or sponsor information or objectives or by tracking actual activities and results or changes in behavior as expected or predicted by customers or other end users or classes or categories of uses or by device, location or payment method.

In a further embodiment, existing or prospective end users or customers receive one or more incentives, marketing messages or other benefits, which are provided by one or more third parties, including, for example, third party sponsors. For example, when a customer receives a 10% discount for using a WCD), the WCD manufacturer pays part or all of such discount for some or all such offers, on a temporary, periodic or permanent basis, so as to encourage use of their equipment or software. In another example, such an offer may be partially or fully subsidized by an unrelated third party sponsor. For example, a telecommunications company offers an existing or prospective customer a free item if such customer will order from a quick serve restaurant chain location and view an advertisement for telecommunications company or fill out a survey or perform some other action or accept a subsequent or related optional or required offer, etc. In this fashion, third party advertisers, for example, sponsors, are able to achieve their marketing objectives, while the business, for example, the quick service establishment, is able to drive more business to generally more desirable locations, devices or payment methods or increase their sales, while customers benefit financially or via other incentives, which incentives may be paid in whole or in part, temporarily, periodically or permanently by such third party sponsors.

In a further embodiment, a present invention offer includes a discount. Such discounts can be associated or applied to specific items within the offer, or to the entire offer contents. In one embodiment, discounts are determined based upon rules established by management of the system or marketing program or as established or modified from time to time by any authorized personnel, or may be initially established or modified using a learning system, e.g., a genetic algorithm, such as programs 314. In any such case, the present invention can make use of any or all available information, including, but not limited to customer information. Discounts can be designed to maximize, minimize or optimize any one or more business or customer objectives as desired or indicated. In another embodiment, the discount, if any, is presented to the customer as a percentage discount or as a cents or other amount off discount.

In one embodiment, discounts in incentives are used/tried relatively sparingly to determine the price elasticity of customers, both as a whole or by class, group, demographics, type or order contents, base order amounts, or specific customer's buying habits and acceptance/rejection information. In this fashion, the present invention can, over time, yield optimal results by learning or otherwise determining what incentives, if any, are required given the known information. For example, if customer A never orders item 1 with item 2, the present invention could include in the offer a 10% discount to combine items 1 and 2 in an order. If the customer rejects such offer, the present invention could attempt the same or similar offer upon the next customer's order entry, but this time offer a larger discount, for a 20% discount. Once the present invention determines a customer's price point, or the customer becomes habituated to ordering the item or service in the offer, the present invention can reduce or eliminate related discounts or other incentives.

In another embodiment, the present invention, having acquired data regarding customer price elasticity and other information, uses such information to determine other offers for the same or generally similar customers, e.g., other customers who purchase item 1 but do not typically purchase item 2. In a further embodiment, using such logic, the present invention determines classifications of customers and leverage use of such information by providing ideal order offers that are also optimized from the location or location management perspective/objectives.

In one embodiment, the offer includes a graphic representation of some or all of the items or services in the offer. In another embodiment, the offer display includes the original or full menu board price for an item or a discounted price for the item. Such discount might be conveyed as a percentage, e.g., 10% off, or using a dollar savings amount, e.g., $0.45 off the ideal order.

Customers can select an offer by any available means, including, for example, touching a screen with such one or more offers, touching a cell phone button, for example, touching a number that corresponds with one or more such offers, or speaking a command, e.g., if ordering via a voice recognition system.

In another embodiment, the present invention provides incentives for existing end users or customers to encourage their friends, acquaintances or associative to make use of generally more desirable devices, locations or payment methods. For example, existing users of such devices, locations or payment methods, or based upon other criteria, are notified or encouraged to shift transactions to one or more such locations, devices or payment methods. Such notices can include one or more marketing offers or incentives that such a person can benefit from if they are successful in convincing one or more such friends, acquaintances or associates to sign up, opt in or otherwise make use of such devices, locations or payment methods. Such methods to determine which existing customers or end users to send such offers or incentives may be accomplished via any applicable means, including, for example, as described in commonly-owned U.S. patent application titled: “SYSTEM AND METHOD FOR PROVIDING INCENTIVES TO AN END USER FOR REFERRING ANOTHER END USER,” inventors Otto et al., filed concurrently, which application is incorporated by reference herein.

In a further embodiment, offers are sent to prospective customers having an identity previously provided by an existing customer, as described in commonly-owned U.S. patent application titled: “SYSTEM AND METHOD FOR PROVIDING INCENTIVES TO AN END USER FOR REFERRING ANOTHER END USER,” inventors Otto et al., filed concurrently, which application is incorporated by reference herein. In such cases, a customer refers a new or prospective member by providing an identification means, for example, a cell phone number. Once this information is made available, such prospective customer receives a marketing message or offer based in whole or in part upon such prospective member's location. For example, if an existing quick service restaurant chain customer provides one or more prospective customer's cell phone number, a present invention system may wait until such prospective customer is near one of the quick service restaurant chain's participating locations and then send such prospective member a message or offer, providing the identity of the referring party along with such message or offer. In addition or in the alternate, a present invention system could monitor the general or other travel habits of such referral, for example, prospective member, and then send one or more marketing offers or messages based in whole or in part on such information. For example, if the system determines that a prospective member more frequently passes by a particular quick service restaurant chain location, offers are sent to the prospective member to visit the particular location as this location, as it would appear to be generally more convenient for such prospective member.

Thus, the present invention provides a means to further optimize or discriminate among existing or potential members or customers in determining which offers, offer types, marketing messages, coupons, or other communications should be sent or suppressed based upon such habits, tendencies, patterns, locations, travel directions or any other data. Using the present invention, retailers, businesses, advertisers, sponsors and other third parties can use information or data to determine or to assist in determining when and to whom to make marketing offers or send marketing messages or provide discounts or other incentives. This discrimination provides a means to improve overall marketing success and aids in targeting existing or prospective customers by using or otherwise exploiting such information.

In one embodiment, offers are made within an establishment. In addition to or in the alternate, such establishment can make offers to existing or prospective customers before they enter such establishment, for example, while walking or driving by such establishment. While inside an establishment, marketing messages or offers may be delivered to existing or potential customers via any applicable means, including a WCD, for example, via cell phone, PDA or via any other means of communication such as use of electronic shelf labels, displays, TV's, speakers, lights, etc. For example, as a customer is walking by or near a given retail display, for example, an “end cap” that has items that may be of interest to such customer, the present invention sends a marketing message or offer that may a) describe the item or items available for sale, including, for example, features, benefits, competitive advantages, etc., or b) provide an offer for sale which may or may not include a discount or other financial incentives, for example, a buy one get one free promotion or a rebate offer. Both (a) and (b) would include a reference to hardware to be used to place an order in response to the offer.

In one embodiment, items, services, or incentives for an offer are determined or based upon any available information including, for example, one or more or any combination of any business objectives, or customer identification, customer information, customer objectives, or customer historic data such as buying habits, tendency to accept or reject any offers or similar offers, or based upon such acceptance with or without a discount, or the amount of or type of discount, willingness to accept specific items or classes of items, or whether or not such items are complementary to base order items, a usual, preferred, or last ordered items, general price elasticity as determined by prior ordering habits or those of similar customers, or classes of customers, or for a given store or location, or based upon the time of day, day of week, month, year, the weather, competitive information, such as information about current marketing campaigns, discounts, marketing offers, and like from one or more competitors.

In another embodiment, in order to receive or otherwise qualify to receive such targeted marketing messages or offers, end users, that is, existing or prospective customers are required to opt in to a cellular marketing program or some other loyalty program indicating their desire or providing permission for such marketing system or company to send one or more such marketing offers or messages. In this fashion, only those interested in such communications will be sent such communications.

In a further embodiment, such customers or prospective customers indicate the type of offers or the frequency of offers or the value of such offers, for example, amount or type of discount, etc., that they wish the system to consider before sending any one or more such offers. For example, a cell phone subscriber can opt in to a cellular marketing network, indicating a general willingness to accept offers, but then restrict the system from making certain offers or offer types or within certain categories, for example, such cell phone subscriber may be willing to accept discount offers from specific business entities but not from any others, or may accept from other retailers, but only when or if such other retailer's provide a discount greater than 20% off the usual price for the offered item or items. Using an interface to permit designation of such preferences, end users, for example, existing or prospective customers can provide the present invention with additional customer information that can help the present invention determine when or if such marketing offers are made and at what discount.

In another embodiment, customers identify themselves using overt actions, e.g., by swiping a card. In a further embodiment, in addition or in the alternative to providing such identification means overtly, customers identify themselves passively, including, for example, by providing a cell phone number, GPS identification number or IP address, or a license plate number. Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008, are applicable to customer identification. In yet another embodiment, the present invention uses such identification means to retrieve information about a customer, e.g., customer, business or sponsor information, which information is used to better or optimally determine if an offer or marketing message should be sent or otherwise provided to the customer.

In one embodiment, the present invention further determines which offers to make or to suppress based upon other performance data or results. In another embodiment, the present invention considers the impact of one or more offers on a customer's ability or proclivity to game or fish the system and avoids or ceases making offers or changes the type of offers generated and transmitted for a given customer or class of customers. For example, if a customer receives one offer to visit a given location at a given time, the system does not make another such offer if such customer accepts said offer, or the system does not make another such offer or other similar offer until a certain predefined or otherwise determined delay, for example, one month. This technique is employed to help ensure that offers, if or when accepted, are generally accretive and are not dilutive to existing sales and profits.

In another embodiment, offers or incentives vary from customer to customer or from time to time, or in whole or in part are consistent regardless of the customer, or time or other information. In cases where offers vary, such offers can be determined via any applicable means and using any available information to make such determination, including, for example, any available customer, business or sponsor information or any one or more customer, business or sponsor objectives or any combination of the forgoing. Such offers or messages can be further determined or modified based upon information or needs or business objectives of one or more suppliers or competitors of such suppliers. For example, a customer receives an offer to purchase, for example, buy two, two liter bottles of a beverage for the price of one. Such customer may accept such message or may receive an additional message, for example, buy two, two liter bottles of a competitor's beverage and get both for the price of one, plus one additional six pack of small cans of the competitor's beverage. In this fashion, product providers or producers or retailers or distributors may provide one or more incentives to purchase one or more products, which offers may or may not be influenced by or competitive with any other such offers.

In one embodiment, the system determines when and what types of offers to present based upon current or previous buying habits or any other available information regarding a customer. If for example, the customer is a loyal customer for item A, the system may not include an incentive with the offer and/or may send a different offer or message depending upon any known factors, for example, did the end user receive or act upon an offer for item B. If the end user did receive or act upon an offer for item B, in another embodiment, the system includes in a reminder regarding item A, blandishments to purchase item A instead of item B, or provide incentives matching or exceeding incentives in a reminder for item B, or query such loyal (or other) customer to determine what such customer would require in a reminder for item A to respond to the offer. In this fashion a competitive environment is created.

In a further embodiment, the end user of the system modifies the rules or method of operation so as to favor itself. For example, in the previous example, if the producer of item A were the sole end user of a present invention system, the producer may choose to not share any part or all of any such customer information or may use knowledge of any reminder regarding item B to its benefit. In another example, if a grocery chain was the sole end user of the system, the end user may choose to provide equal access to the system or favor one or more of its suppliers based upon any one or more of its business objectives, e.g., the profitability or perceived or actual quality or consistency or pricing of such one or more suppliers.

In one embodiment, offers are determined, in whole or in part, by two or more competing entities, for example, if a WCD is in the geographical area of two or more restaurants for which the WCD has received communications, the system determines the content of the respective reminders for the competing entities, in whole or in part, based upon any one or more or a combination of any or all of the following, including, for example, the general distance of the WCD from the restaurants, willingness of one or more owners or operators of the restaurant to pay for the generation and transmission of respective reminders, or the probability the end user of the WCD will respond favorable to a reminder, such as implementing an offer included in a communication, or based upon a transaction history for the end user or the WCD, for example, is the end user already a loyal customer of one or more of the restaurants, or any other available information regarding the restaurant (for example, a business), customer or sponsor's goals, objectives or information, which determination may be made via any applicable means, including, for example, use of a table-based, rules based or AI based system, including use of any genetic algorithms to improve performance over time.

For example, if a WCD associated with a loyal customer of restaurant A is approaching an area that contains both a restaurant A and a restaurant B, a present invention system licensed by a cell phone company, could transmit an offer regarding restaurant B. As another example, if a present invention system were exclusively licensed by restaurant A, restaurant A could choose to only send an offer regarding restaurant A or to increase the incentive included in such an offer only in the event it is determined that the WCD is about to or does enter the parking lot for restaurant B or actually enters restaurant B. In another example, if restaurants A and B were both non-exclusive licensees of the disclosed invention, each could choose to send one or more offers as applicable. Such offers can be based, in whole or in part, upon whether or not a WCD having received earlier communications from the restaurants is approaching a competitive location or if the transaction history for an end user of the WCD is known. For example, it is known by one or both such restaurants that the end user visits one of the restaurants more often than the other, in which case, reminders can be made to encourage continued loyalty and/or to switch brands.

In one embodiment, the present invention determines a location of a current or prospective customer. Such determination may be made using any applicable means, including, for example, using a method of triangulation of a given WCD, such as a cell phone or PDA device. Methods to locate, within a given distance a given cell phone or other cellular device, for example, a PDA equipped with cellular communications abilities, are well known by those of ordinary skill in the art and in the prior art. By considering a customer or prospective customer's current location or by estimating a destination or route of travel, a marketing system can better determine if such customer or prospective customer is or will be in the general vicinity of a given location, for example, a restaurant or retail outlet, or within a specific area within such an establishment. Such knowledge can be used to determine when or if to make certain offer types or what level of discount should be provided, if any.

For example, if a person with a cell phone has just passed by a quick service restaurant chain, the disclosed system could: a) determine if such cell phone owner is or is not an existing customer, b) if such person is not a customer such a system could provide such person with an offer, c) if such person is a current customer the system could further determine if such customer routinely visits such location anytime, at the current time, for example, comes often for lunch, but never for dinner, and other customer information may be assessed to determine what, if any offer should be made and what, if any discount should be provided to such customer. Once such information is made available to the present invention, the present invention can make better informed decisions as to the type of offers to make, if any, when, and at what discount level(s), if any.

For example, if a loyal quick service restaurant chain customer is passing by a particular restaurant during the dinner hours, and such customer regularly visits this or other restaurants for lunch, but rarely, if ever, visits this or other quick service restaurant locations for dinner, the present invention can offer a free or discounted item or meal if such customer visits now or at some future date during certain hours, for example, 5 pm to 11 pm.

In a further embodiment, marketing messages, content, offers, incentives, etc., are created or maintained centrally or in a distributed network, including, for example, locally. Such management may be accomplished via any applicable means available, including, for example, making use of existing, for example, off the shelf or customized tools that provide for such creating, management or distribution. In one embodiment, in an effort to further control or determine which offers to make or to determine which offers are generally more or less desirable, or to otherwise improve one or more aspects of the system, the present invention accesses certain information from existing systems, including, for example, existing point of sale (POS) databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In one embodiment, the system tracks individual and classes of existing or prospective customers so as to further improve results of the system. For example, in the event that limited transaction history information is available for an end user of a WCD receiving a communication, such as an offer, the system accumulates such information to determine when and how to generate and transmit reminders and what incentives, if any, to include with the reminders. The system can accumulate information regarding rejection and acceptance of offers and reminders, and other parameters regarding the offers and reminders such as types, incentives included, associated locations, items included, offer types, and discount levels.

In another embodiment, the present invention provides information to a potential purchaser of a product, informing him/her about any one or more customers in the area that have made a similar purchase. For example, if a prospective customer is seeking information about a particular car, the system provides information or a link to establish communications with other purchasers of the same or similar car or cars purchased from the same manufacturer or distributor/dealer, etc. In a further embodiment, such prior purchasers are first required to opt into such a program before any part or all of their information is supplied to such prospective customer(s). Such willingness may or may not include receipt of a fee for providing such information. Such fee may be paid upon providing the information, upon sharing of the information or upon a user of such information making a purchase, which purchase may or may not have been made based, in whole or in part, upon such information or any combination of the foregoing. In this manner, a network can be created to provide prospective buyers with access to information and opinions of previous buyers of the same or similar products, goods, or services. Such “word of mouth” networks are well known in society, but the present invention automates and facilitates such word of mouth communications among prospective and existing customers in ways not possible using manual social networks, including, for example, the hereinabove disclosed method of connecting prior buyers with prospective buyers, even in the case where such individuals or groups are unaware of each other's previous buying habits.

In one embodiment, in the event an existing customer's information is provided to a prospective buyer, such prospective buyer is requested or required to provide such existing customer with additional information concerning one or more products, goods or services of interest to such existing customer that such prospective customer may have purchased or is otherwise familiar with based upon such prospective customer's previous buying history.

In another embodiment, before sharing an existing customer's information with a prospective buyer, such prospective buyers prior buying history is provided or is analyzed, by the present invention or by the existing customer to determine if any such prospective customer's prior purchases are or may be of interest to such existing customer. In this manner, such existing customer may be permitted to determine if such prospective customer has any information of use to such existing customer before sharing any information of such existing customer with such prospective customer or before sharing such existing customer's identity.

In a further embodiment, rankings or scores are provided by users of such prior history or buying or satisfaction information so that potential future users of such information might better determine which information to use or accept or which information might be suspect. For example, if customer A purchases a car, and then provides feedback to prospective customers X, Y and Z, each of such prospective customers might rank the usefulness or accuracy of such information so that any future prospective customer might be advised as to other's perception of such customer A's ability to make or provide future purchase advice or information or feedback.

In one embodiment, the present invention improves results over time or with use of the invention. Such improvement or optimization can be accomplished via any means necessary including any of several methods well known in the art or as disclosed by applicants and incorporated herein by reference, including, for example, commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008. For example, statistical methods can be used to determine which marketing messages, offers, incentives, content or other communications generally yield the desired or optimal or generally better results, or such results may be determined using one or more genetic algorithms, or a present invention administrator/operator can review results reports and then provide manual weighting criteria to further define or control the system, or a combination of these and other well known methods may be employed in any combination or in any order or priority.

In one embodiment, the offer includes a graphic representation of some or all of the items or services in the offer. In another embodiment, the offer display includes the original or full menu board price for an item and/or a discounted price for the item. Such discount might be conveyed as a percentage, e.g., 10% off, and/or using a dollar savings amount, e.g., $0.45 off the ideal order.

In one embodiment, items, services, or incentives for an offer are determined or based upon any available information including, for example, one or more or any combination of any business objectives, or customer identification, customer information, customer objectives, or customer historic data such as buying habits, tendency to accept or reject any offers or similar offers, or based upon such acceptance with or without a discount, or the amount of or type of discount, willingness to accept specific items or classes of items, or whether or not such items are complementary to base order items, a usual, preferred, or last ordered items, general price elasticity as determined by prior ordering habits or those of similar customers, or classes of customers, or for a given store or location, or based upon the time of day, day of week, month, year, the weather, competitive information, such as information about current marketing campaigns, discounts, marketing offers, and like from one or more competitors,

Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices;” and commonly-owned U.S. patent application Ser. No. 12/151,038, filed May 2, 2008 and entitled “Method and Apparatus for Generating and Transmitting an Order Initiation Offer to a Wireless Communications Device,” are applicable to end user identification. In one embodiment, the present invention uses such identification means to retrieve information about a customer, e.g., customer, business or sponsor information, which information is used to better or optimally determine if an offer or marketing message should be sent or otherwise provided to the customer.

In a further embodiment, the present invention improves results over time and/or with use of the present invention. Such improvement or optimization can be accomplished as described supra. For example, statistical methods can be used to determine which marketing messages, offers, incentives, content or other communications in an offer generally yield the desired or optimal or generally better results. Also such results can be determined using one or more genetic algorithms or sets or rules. Further, a present invention end user can review results reports and then provide manual weighting criteria to further define or control the present invention. As well, any combination of the foregoing can be employed in any combination or in any order or priority.

The present invention can perform the following functions:
1. Identify an end user. For example, end users that have signed up or otherwise “opted in” to a loyalty or marketing program, may have agreed to permit the system to retain customer information. Such information may include one or more IP addresses or other means of identification, for example, GPS or cell phone identification information, payment methods or preferences, e.g., credit card numbers or other financial payment methods/instruments, order history or preferences or any other useful customer information.
2. Retrieve prior order history, if available.
3. Display information or one or more choices to the end user, including, for example, an ideal order as described in U.S. patent application titled: “METHOD AND APPARATUS FOR GENERATING AND TRANSMITTING AN IDEAL ORDER OFFER,” inventors Otto et. al, filed concurrently; a real-time or deferred offer as described in U.S. patent application titled: “METHOD AND SYSTEM FOR GENERATING A REAL TIME OFFER OR A DEFERRED OFFER,” inventors Otto et. al, filed concurrently; or a location based offer as described in U.S. patent application titled: “SYSTEM AND METHOD FOR GENERATING AND TRANSMITTING LOCATION BASED PROMOTIONAL OFFER REMINDERS,” inventors Otto et. al, filed concurrently, which applications are incorporated by reference herein.
4. Enable an end user to interact with the system to: a) retrieve information, b) obtain directions to the nearest or a preferred location, c) view special offers that may apply to any or selected locations, for example, a location that is currently not busy or has excess stock, or is farther away than another similar or competing location may provide an offer, discount or one or more specialized marketing messages or offers, which may include a discount, which discount may or may not be greater or less than discounts offered other end users based upon any one or more discriminating factors, such as: a) distance from location, b) orientation with location, for example, is location “on the way” or in generally the same direction as the end user is presently traveling or is planning to travel (plans determined or based upon, in whole or in part, a previously determined or selected route or current or planned destination address, c) distance from end user and/or between end user and desired location and/or competitive location(s), d) prior order history or any other available customer information, e) any business or sponsor information, f) any one or more objectives of the customer (for example, end user) or business objective or sponsor objective, or based upon any other information available, such as inventory information, hours of operation, current or expected or projected sales volumes, labor availability, etc.
5. Initiate and/or complete a transaction. For example, the system may permit an end user to: a) retrieve a pending order and complete it, by making changes/additions/deletions or provide payment authorization, and then b) pick up the order at the nearest location, or the nearest location along the end user's current or planned route, c) receive one or more marketing offers and/or messages, for example, an ideal order as described in U.S. patent application titled: “METHOD AND APPARATUS FOR GENERATING AND TRANSMITTING AN IDEAL ORDER OFFER,” inventors Otto et. al, filed concurrently; a real-time or deferred offer as described in U.S. patent application titled: “METHOD AND SYSTEM FOR GENERATING A REAL TIME OFFER OR A DEFERRED OFFER; or a location based offer as described in U.S. patent application titled: “SYSTEM AND METHOD FOR GENERATING AND TRANSMITTING LOCATION BASED PROMOTIONAL OFFER REMINDERS,” inventors Otto et. al, filed concurrently, retrieve a previously started order, for example, an end user may fill a shopping cart with one or more desired items while at home using a laptop or PDA, or PC, or via a cell phone or other ordering device, regardless of initial entry method, the disclosed system permits such an end user to retrieve such previous order(s) so as to review, cancel, pay or otherwise modify or interact with such previous order(s). For example, a fast food restaurant customer/end user might retrieve their “usual order” and accept payment, which, in turn can initiate a production process or method. For example, when the end user is approaching a location for the restaurant, such customer's previous order, or usual order, or other marketing message or offer, or any combination of the forgoing, may appear as choices on such customer's WCD. Such customer could perform any of several steps including, for example, a) do nothing and simply ignore the offers, information, etc., in which case, the system may provide additional information, e.g., a discount offer, or spoken marketing message or offer, or may return the display to its previous state, which time or delay may be determined via any applicable means, including, for example, a predetermined amount of time, or an amount of time established by the end user, or based upon prior actions taken by such end user, for example, how long before typically accepting an offer or touching an unrelated option, b) accept any one or more of such offers, c) modify the contents of an order or initiate a new order, d) authorize production and/or payment of the order, e) authorize payment upon arrival at a restaurant location, for example, after creating, modifying or accepting an order or marketing message or offer, or any combination of the foregoing, the system might delay sending such order to a kitchen production system or delay payment processing until the customer either i) arrives on the parking lot of the restaurant location, or ii) approaches such location, iii) enters the drive through lane or enters the location, or iv) via any other event or other means, for example, turns off their car, presses a button or other icon on a WCD or other EUD, provides a voice or other command, etc., f) execute a program, makes a selection from one or more choices, or takes any other action, or fails to act, etc.
6. Display one or more related or unrelated navigational buttons or icons. For example, a “return” button may enable the end user to go back to a previous display while an “information” button may enable the end user to learn more about a given offer or the system, or other choices on the display, etc.

In one embodiment, without necessarily requiring any end user action or inaction, the system may automatically display a previous or preferred order for the end user or one or more marketing messages or offers on an end user's WCD based upon the WCDs current or predicted location or based upon any proximal data or other available information, such as any available system, customer, business, or sponsor information, or any customer, business and/or sponsor objectives, or any combination of any the foregoing information or objectives, as described in U.S. patent application titled: “SYSTEM AND METHOD FOR GENERATING AND TRANSMITTING LOCATION BASED PROMOTIONAL OFFER REMINDERS,” inventors Otto et. al, filed concurrently.

In one embodiment, the actions described above require an end user to previously agree to receive such displays, orders, marketing messages or offers, for example, by opting into a program designed for such purposes, for example, a marketing or loyalty program, or online ordering or POS or other system.

In one embodiment, in any event, an end user is enabled to accept or reject or modify any one or more orders, offers, etc., or may authorize production, preparation, assembly, or delivery or pickup and/or payment of any such order, offers, discounts, items, messages, etc. For example, a fast food restaurant customer might order their usual or preferred order, and authorize payment remote from a restaurant location and then, upon arrival at a restaurant location, or at some determined time just prior to or just after such arrival, the system or end user (e.g., customer) can initiate production of such order. For example, if the system determines that it will require two minutes and thirty seconds to prepare an order, and the customer usually comes into the store they are heading to presently, the system can calculate the time it will require such customer to complete the journey and enter the store, and then work backward to determine the optimal time to send the order to the kitchen. If such customer tends to use the drive through, a similar process may be employed, while adding or accounting for the time required for existing or projected cars to clear out of the drive through lane, for example, if the restaurant has three cars in the drive through, and one additional car is expected prior to such end user's arrival at the restaurant, and, speed of service times are averaging 30 seconds per car, the system might initiate the end user's order upon the end user pulling onto the lot, or can wait 30 seconds or a minute, so as to ensure high quality, and hot food, or in one embodiments, end user's making use of some or all of the disclosed invention, may opt to skip the drive through line altogether, and park in one or more designated spaces, and an employee may deliver the food to the car, thus permitting the end user to skip the ordering, payment and line time inconveniences. In one embodiment, additional information regarding other factors that could influence arrival time, for example, weather and traffic conditions, are gathered using any means known in the art and are accounted for in the calculations described supra.

The following is a listing of exemplary hardware and software that can be used in a present invention method or system. It should be understood that a present invention method or system is not limited to any or all of the hardware or software shown and that other hardware and software are included in the spirit and scope of the claimed invention.
1. Hardware: Central Controller
2. Software: Offer Generation and Transmission Program and Order Fulfillment

Program

The following is a listing of exemplary data bases that can be used in a present invention method or system. It should be understood that a present invention method or system is not limited to any or all of the databases shown and that other databases are included in the spirit and scope of the claimed invention.
1. Device Database: Device ID and Device Profile.
2. Offer Database: Offer identification; Offer content; Offer rules and conditions; and Business entity location.
3. Business Entity Database: Business Entity identification and Business Entity information.
4. Offers Displayed Database: Offer identification; Display date; Display device; and Display rules and conditions
5. Transaction Database: Transaction identification; Offer identification; Business entity; Business entity identification; and Device identification.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for providing a location based offer, comprising the steps of:
generating, using a processor in at least one specially programmed general-purpose computer, at least one respective offer for at least one item or service from at least one first business entity, the offer for display on a map showing respective locations for the at least one first business entity;
transmitting, using the interface element, the at least one respective offer to a wireless communications network for transmission to a wireless communications device (WCD) for display on a map by the WCD, the map including the respective locations; and,
receiving, from the WCD via the wireless communications network and using the interface element, a selection of an offer from among the at least one respective offer, wherein the at least one respective offer is generated by using at least one of a first set of rules or a first artificial intelligence program stored in a memory unit for the at least one specially programmed general-purpose computer, or wherein the at least one respective offer is transmitted according to at least one of a second set of rules or a second artificial intelligence program stored in the memory unit.

2. The method of claim 1 including the steps of:
storing, in the memory unit, information regarding historical acceptance of previously presented offers; and,
modifying the first or second set of rules according to the information regarding historical acceptance of previously presented offers.

3. The method of claim 2 wherein the previously presented offers are for items or services from the at least one first business entity.

4. The method of claim 2 wherein the previously presented offers were sent to the WCD or to an end user associated with the WCD.

5. The method of claim 1 including the steps of:
storing, in the memory unit, data regarding information searches previously performed using the WCD or by an end user of the WCD; and,
modifying the first or second set of rules according to the data regarding information searches.

6. The method of claim 1 further comprising the step of receiving, from the WCD via the wireless communications network and using the interface element, a request for an item or service and wherein generating at least one respective offer includes generating the at least one respective offer to include the item or service.

7. The method of claim 1 further comprising the steps of:
storing at least one third rule in a memory element for the WCD; and,
executing, using a processor in the WCD, the at least one respective offer according to the at least one third rule.

8. The method of claim 1 further comprising the steps of:
receiving, using the interface element, at least one third rule from the WCD, or from a general-purpose computer associated with a second business entity;
storing the at least one third rule in the memory unit; and,
modifying the at least one offer using the processor and the at least one third rule and wherein transmitting the at least one offer includes transmitting the modified at least one offer.

9. The method of claim 1 further comprising the steps of:
identifying, using the processor and the interface element, the WCD; and,
determining eligibility of the WCD using the processor and at least one of a third set of rules or a third artificial intelligence program stored in the memory unit, wherein generating the at least one respective offer includes generating the at least one respective offer only if the WCD is determined to be eligible, or wherein transmitting the at least one respective offer includes transmitting the at least one respective offer only if the WCD is determined to be eligible.

10. The method of claim 1 further comprising the step of determining a location for the WCD.

11. A system for providing a location based offer, comprising:
an interface element for at least one specially programmed general-purpose computer;
a memory unit for the at least one specially programmed general-purpose computer; and,
an offer element, in a processor for the at least one specially programmed general-purpose computer for:
generating, using the processor and at least one of a first set of rules or a first artificial intelligence program stored in the memory unit, at least one respective offer for at least one item or service from at least one first business entity, the offer for display on a map showing respective locations for the at least one first business entity;
transmitting, using the interface element and according to at least one of a second set of rules or a second artificial intelligence program stored in the memory unit, the at least one respective offer to a wireless communications network for transmission to a wireless communications device (WCD) for display on a map by the WCD, the map including the respective locations; and,
receiving, from the WCD via the wireless communications network and using the interface element, a selection of an offer from among the at least one respective offer.

12. The system of claim 11 wherein the offer element is for:
storing, in the memory unit, information regarding historical acceptance of previously presented offers; and,
modifying the first or second set of rules according to the information regarding historical acceptance of previously presented offers.

13. The system of claim 12 wherein the previously presented offers are for items or services from the at least one first business entity.

14. The system of claim 12 wherein the previously presented offers were sent to the WCD or to an end user associated with the WCD.

15. The system of claim 11 wherein the offer element is for:
storing, in the memory unit, data regarding information searches previously performed using the WCD or by an end user of the WCD; and,
modifying the first or second set of rules according to the data regarding information searches.

16. The system of claim 11 wherein the offer element is for:
receiving, from the WCD via the wireless communications network and using the interface element, a request for an item or service; and,
generating the at least one respective offer to include the item or service.

17. The system of claim 11 wherein the WCD includes a memory element for storing at least one third rule, and a processor for executing the at least one respective offer according to the at least one third rule.

18. The system of claim 11 wherein the offer element is for:
receiving, using the interface element, at least one third rule from the WCD, or from a general-purpose computer associated with a second business entity;
storing the at least one third rule in the memory unit;
modifying the at least one offer using the processor and the at least one third rule; and,
transmitting the modified at least one offer.

19. The system of claim 11 wherein the offer element is for:
identifying, using the processor and the interface element, the WCD;
determining eligibility of the WCD using the processor and at least one of a third set of rules or a third artificial intelligence program stored in the memory unit; and,
generating the at least one respective offer only if the WCD is determined to be eligible; or,
transmitting the at least one respective offer only if the WCD is determined to be eligible.

20. The system of claim 11 wherein the offer element is for determining a location for the WCD.
